(19) United States
(12) Patent Application Publication
(10) Pub. No.: US 2001/0019439 A1
(43) Pub. Date: Sep. 6, 2001

(54) Optical transmission system and node adding method

(76) Inventors: Shiro Ryu, Tokyo (JP); Joichi Mori, Tokyo (JP)

Correspondence Address: CHRISTIE, PARKER & HALE, LLP, P.O. BOX 7068, PASADENA, CA, 91109-7068, US

(21) Appl. No.: 09/798,570

(22) Filed: Mar. 1, 2001

(30) Foreign Application Priority Data
Mar. 1, 2000 (JP) 2000-055221

(51) Int. Cl. H04J 14/02

(52) U.S. Cl. 359/127; 359/173

(57) ABSTRACT

An object of the present invention is to simplify the addition of a node. Nodes (14-1˜14-8) connect to a ring (12) through optical add/drop multiplexers (10-b 1˜10-8). A new ring (20) is constructed next to the ring (12). Disposed on the ring (20) are an optical add/drop multiplexer (28) corresponding to a to-be-added node (26) and an optical add/drop multiplexer (30) to connect the ring (20) with the ring (12). The optical add/drop multiplexer (30) connects with the node (14-5) connecting the ring (12) through a connector (32). The connector (32) mediates signals between the node (14-5) and the optical add/drop multiplexer (30) bidirectionally.

### FIELD OF THE INVENTION

This invention relates to an optical transmission system and a node adding method.

### BACKGROUND OF THE INVENTION

Recently, a demand for non-audio communication such as the Internet has been increasing. To meet the demand, common carriers have been constructing new optical fiber transmission lines. However, an enormous amount of cost is required to construct a new optical fiber cable in urban areas where the demand for the communication is bigger, and accordingly reduction of the cost has become a common object among the common carriers.

In some urban areas, self-governing bodies etc. have already constructed optical fibers in sewage systems and rent a part of the communication capacity to the common carriers. To simplify the maintenance and utilization, a fiber strand is used as a lending unit of the optical fibers.

As an optical fiber network in urban areas, a WDM ring network, composed of a pair of optical fibers to be used for an up stream and a down stream respectively, is suitable for its reliability and transmission capacity.

FIG. 8 shows a schematic block diagram of a conventional WDM ring system. In this example, eight optical add/drop multiplexers 110-1˜110-8 are disposed on a ring 112, and nodes or optical transmitting/receiving terminal stations 114-1˜114-8 connect to each of the optical add/drop multiplexers 110-1˜110-8. The ring 112 is composed of optical fibers 116 (116-1˜116-8) on which signal light propagates counterclockwise and optical fibers 118 (118-1˜118-8) on which signal light propagates clockwise. Each of the optical add/drop multiplexers 110-1˜110-8 is set so as to add/drop light having a specific wavelength and generally drops light having a wavelength assigned to each of the connected nodes 114-1˜114-8 for receiving. In general, the wavelengths in which the respective add/drop multiplexers 110-1˜110-8 are to add/drop are necessarily different from each other.

Each of the optical add/drop multiplexers 110-1˜110-8 connects to the adjacent optical add/drop multiplexers on either side through the optical fibers 116-1˜116-8 and 118-1˜118-8, and consequently the ring 112 is formed. For instance, the optical add/drop multiplexer 110-1 connects to the optical add/drop multiplexer 110-2 through the optical fibers 116-1 and 118-1 and also connects to the optical add/drop multiplexer 110-8 through the optical fibers 116-8 and 118-8.

Since the clockwise optical transmission line and the counterclockwise optical transmission line are both constructed, even if one optical transmission line (e.g. the clockwise optical transmission line) has a fault, the respective nodes 114-1˜114-8 can communicate with the other nodes 114-1˜114-8 through the remaining optical transmission line (e.g. the counterclockwise optical transmission line).

FIG. 9 shows a schematic block diagram of the optical add/drop multiplexer 110-1 and the node 114-1. The configurations of the other optical add/drop multiplexers 110-2˜112-8 and nodes 114-2˜114-8 are just the same.

WDM signal light from the optical fiber 116-1 enters an optical DROP circuit 120a in the optical add/drop multiplexer 110-1. The optical DROP circuit 120a exclusively extracts signal light having a wavelength (here, λi) assigned to the node 114-1 in order to apply to an optical receiver 122a and applies signal light having the other wavelengths to an optical ADD circuit 134a. The optical receiver 122a converts the input signal light into an electric signal and applies it to a demultiplexer 124a. The output from the optical receiver 122a is composed of a plurality of signals multiplexed in the time domain. The demultiplexer 124a demultiplexes the output signal from the optical receiver 122a in the time domain and outputs as respective received signals 126a-1˜126a-n.

In the meanwhile, signals 128a-1˜128a-n to be transmitted to the other nodes 114-2˜114-8 are applied to a multiplexer 130a. The multiplexer 130a multiplexes the signals 128a-1˜128a-n in the time domain and applies them into an optical transmitter 132a. The optical transmitter 132a converts the time-domain multiplexed signal from the multiplexer 130a into signal light to be carried by light having a wavelength assigned to a destination node. The optical ADD circuit 134a adds, namely multiplexes in the wavelength domain, the output light from the optical transmitter 132a into the light from the optical DROP circuit 120a. An optical amplifier 136a outputs the output light from the optical ADD circuit 134a toward the optical fiber 116-8. The optical amplifier 136a is sometimes omitted.

A procedure system for the signal light input from the optical add/drop multiplexer 110-8 through the optical fiber 118-8 and the data to be transmitted toward the other nodes through the optical fiber 118-1 is basically identical to the aforementioned procedure system.

That is, the WDM signal light from the optical fiber 118-8 enters an optical DROP circuit 120b in the optical add/drop multiplexer 110-1. The optical DROP circuit 120b exclusively extracts signal light having a wavelength (here, λi) assigned to the node 114-1 to apply into an optical receiver 122b while applying signal light having the other wavelengths into an optical ADD circuit 134b. The optical receiver 122b converts the input signal light into an electric signal and applies it to a demultiplexer 124b. The output from the optical receiver 122b is composed of a plurality of signals multiplexed in the time domain. The demultiplexer 124b demultiplexes the output signal from the optical receiver 122b in the time domain and outputs respective received signals 126b-1˜126b-n.

In the meanwhile, signals 128b-1˜128b-n to be transmitted for the other nodes 114-2˜114-8 are applied to a multiplexer 130b. The multiplexer 130b multiplexes these transmission signals 128b1˜128b-n in the time domain and applies them to an optical transmitter 132b. The optical transmitter 132b converts the time-domain multiplexed signal from the multiplexer 130b into signal light to be carried by light having a wavelength assigned to a destination node. A optical ADD circuit 134b adds, namely multiplexes in the wavelength domain, the output light from the optical transmitter 132b into the light from the optical DROP circuit 120b. An optical amplifier 136b outputs the output light from the optical ADD circuit 134b for the optical fiber 118-1. The optical amplifier 136b is sometimes omitted.

In an optical transmission system in which a plurality of nodes are connected in serial, it is difficult to insert a new node between the existing nodes. The reason why it is difficult is that an optical level of each part on an optical transmission system, which is strictly adjusted, deviates from the set value because of the newly added node and requires to be readjusted. In a WDM transmission, it is even more difficult because an optical level per wavelength has to be readjusted.

FIG. 10 shows a block diagram in which an optical add/drop multiplexer 110-9 is inserted between the optical add/drop multiplexers 110-4 and 110-5 in order to add a node 114-9. The optical fibers 116-4 and 118-4 are disconnected in the middle and the optical add/drop multiplexer 110-9 is connected there. That is, the optical add/drop multiplexers 110-4 and 110-9 are connected through optical fibers 116-4a and 118-4a, which are respectively parts of the optical fibers 116-4 and 118-4, while the optical add/drop multiplexers 110-9 and 110-5 are connected through optical fibers 116-4b and 118-4b, which are respectively the rest of the optical fibers 116-4 and 118-4.

Owing to the addition of the optical add/drop multiplexer 110-9 (namely, the node 114-9), loss between the optical add/drop multiplexers 110-4 and 110-5 increases. Although such loss can be compensated by inserting an optical amplifier, this method increases the number of the optical amplifiers and consequently causes noise. In the worst case, there is a possibility that the whole ring system itself cannot operate under regular quality.

In addition, in a WDM transmission system which assigns a receiving wavelength to each node, the number of nodes to be added is limited even the reuse of a wavelength is considered. When the addition of a node is desired nevertheless, a pair of new optical fibers (one for a upstream line and the other for a downstream line) should be constructed from an adjacent node. Although this method is good when a small number of nodes are added, the network becomes complicated as the number of the added nodes increases. This is not preferable because the signal route becomes complicated and/or the traffic sometimes concentrates at a specific node.

When a to-be-added node is distant from a to-be-connected node along the ring 112, an optical fiber to connect the to-be-added node and the to-be-connected node is generally disposed in the same sewer pipe with the ring 112. Therefore, when n nodes are added, 2×n fibers have to be constructed in the sewer pipe. This causes an increase of the rental charge and sometimes it is even impossible to add any more nodes because of the holding capacity of the sewer pipe.

Generally, a node to be added is sufficient if it costs one-tenth of an existing node considering its necessary communication capacity and function (e.g. a transmission rate, the presence of supervisory control function, and the presence of a time-domain multiplexer/demultiplexer, etc.). However, when a new node is connected with the ring 112 similarly to the existing nodes, it is necessary to use a node having a communication capacity and a function to be identical with the existing nodes. Such node has apparently an excess specification.

Furthermore, the optical transmission lines are generally disconnected when a node is added. This is not preferable because it causes short disconnection of optical transmission and consequently communication failure.

### SUMMARY OF THE INVENTION

It is therefore an object of the present invention to provide an optical transmission system to solve the aforementioned problems.

Another object of the present invention is to provide an optical transmission system in which a new node can be easily added.

Further object of the present invention is to provide a method to add a new node to an existing optical transmission system.

An optical transmission system according to the invention is composed of a first optical transmission line to which a plurality of first nodes are connected, a second optical transmission line to which at least one second node is connected, a repeating optical add/drop multiplexer which is disposed on the second optical transmission line, and a signal mediator connected between any one of the plurality of first nodes and the repeating optical add/drop multiplexer in order to mediate a signal between them.

A node adding method according to the invention is composed of a step to install a second optical transmission line separately from a first optical transmission line to which a plurality of nodes are connected, a step to dispose a repeating optical add/drop multiplexer on the second optical transmission line, a step to connect a signal mediator between the repeating optical add/drop multiplexer and any one of the nodes connected to the first optical transmission line in order to mediate a signal between them, and a step to connect an adding node with the second optical transmission line.

### BRIEF DESCRIPTION OF THE DRAWING

The above and other objects, features and advantages of the present invention will be apparent from the following detailed description of the preferred embodiments of the invention in conjunction with the accompanying drawings, in which:

FIG. 1 shows a schematic diagram of an embodiment according to the invention;

FIG. 2 shows a schematic block diagram of a part relating to the connection between optical transmission lines;

FIG. 3 shows a schematic diagram of a modified embodiment according to the invention;

FIG. 4 shows a schematic diagram of another modified embodiment according to the invention;

FIG. 5 shows a schematic block diagram of a connector 32 and an optical add/drop multiplexer 30 shown in FIG. 4;

FIG. 6 shows a schematic block diagram of the embodiment after a large number of nodes are added;

FIG. 7 shows a schematic block diagram of an embodiment according to the invention when applied to a linear transmission line;

FIG. 8 shows a schematic diagram of a conventional ring network;

FIG. 9 shows a schematic block diagram of an optical add/drop multiplexer 110-1 and a node 114-1; and

FIG. 10 shows a schematic diagram of a conventional ring network after a node 114-9 is added.

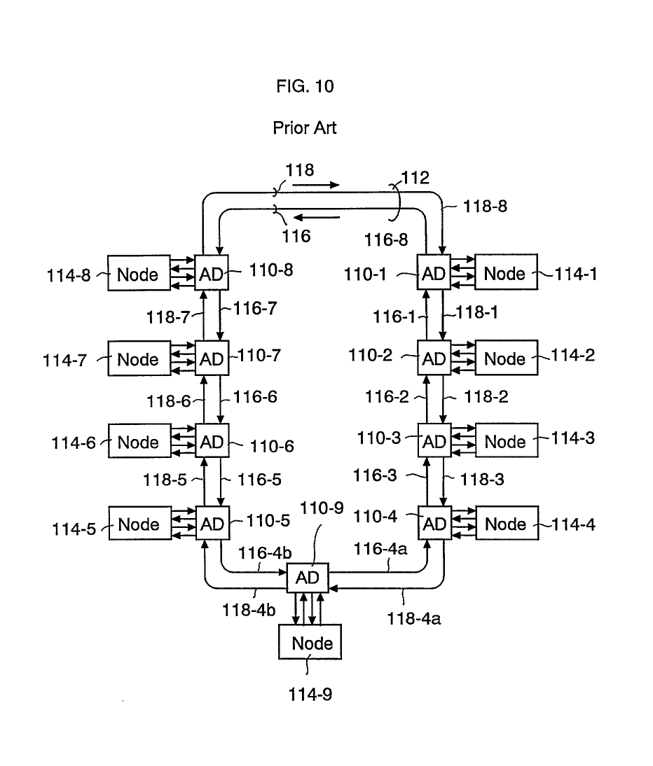

### DESCRIPTION OF THE PREFERRED EMBODIMENT

Embodiments of the invention are explained below in detail with reference to the drawings.

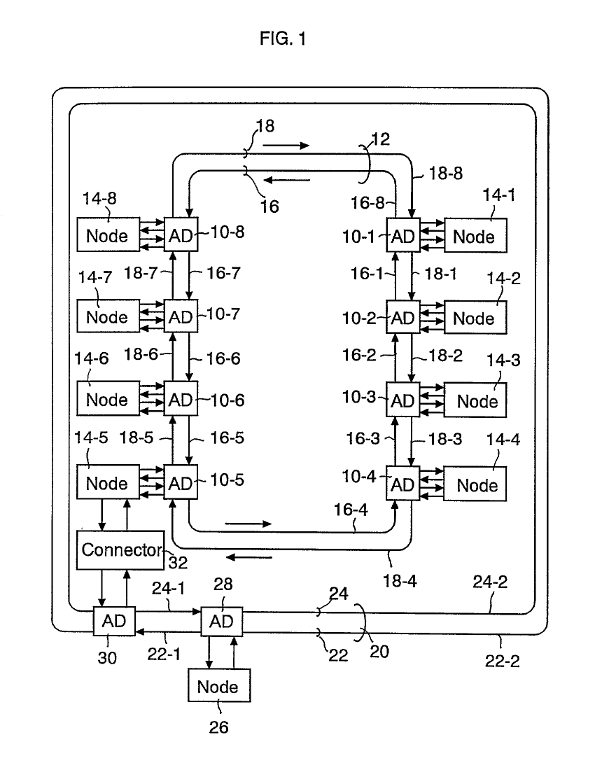

FIG. 1 shows a schematic block diagram of an embodiment according to the invention. FIG. 1 shows a diagram after a new node is added to a conventional WDM optical ring network.

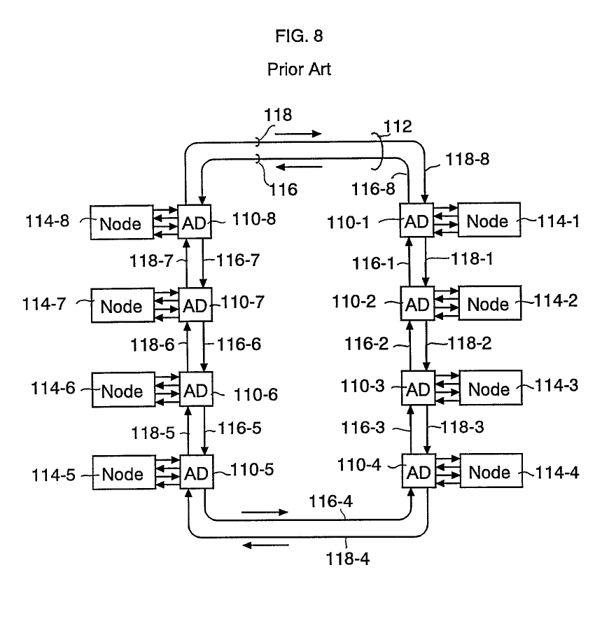

Optical add/drop multiplexers 10-1-10- 8, a ring 12, nodes 14-1˜14-8, and optical fibers 16 (16-1˜16-8) and 18 (8-1˜18-8) respectively have the same configuration and function with those of the conventional optical add/drop multiplexers 110-1˜110-8, the ring 112, the nodes 114-1˜114-8, and the optical fibers 116 (116-1˜116-8) and 118 (118-1˜118-8) shown in FIG. 8. That is, those elements compose an optical transmission system that is already constructed and used. The optical fibers 16-1˜16-8, 18-1˜18-8 and the optical add/drop multiplexers 10-1˜10-8 on the ring 12 are disposed in a sewage system, for instance. It is assumed that a new node (add/drop multiplexer) cannot be connected to the ring 12 in the existing part because of a limit to the number of wavelengths.

In the embodiment, a new ring 20 is installed adjacent to the ring 12, more specifically adjacent to one or a plurality of main nodes among the nodes 14-1˜14-8 connecting to the ring 12, in order to prepare for the occasion to add more than one node. The ring 20 is composed of an optical fiber line 22 which propagates signal light clockwise and an optical fiber line 24 which propagates signal light counterclockwise. Disposed on the ring 20 are an optical add/drop multiplexer 28 which corresponds to a to-be-added node 26 and an optical add/drop multiplexer 30 which connects between the ring 20 and the ring 12. The optical add/drop multiplexer 30 connects to any one of the nodes (in FIG. 1, the node 14-5) connected with the ring 12 through a connector 32.

In the stage shown in FIG. 1, optical fibers 22-1 and 24-1, which connect between the optical add/drop multiplexers 28 and 30 in the optical fiber lines 22 and 24, are practically used for transmitting the signal light while the other optical fibers 22-2 and 24-2 are disposed to prepare for a demand to add more nodes. Accordingly, it is sufficient to dispose the optical fibers 22-1 and 24-1 alone for the present.

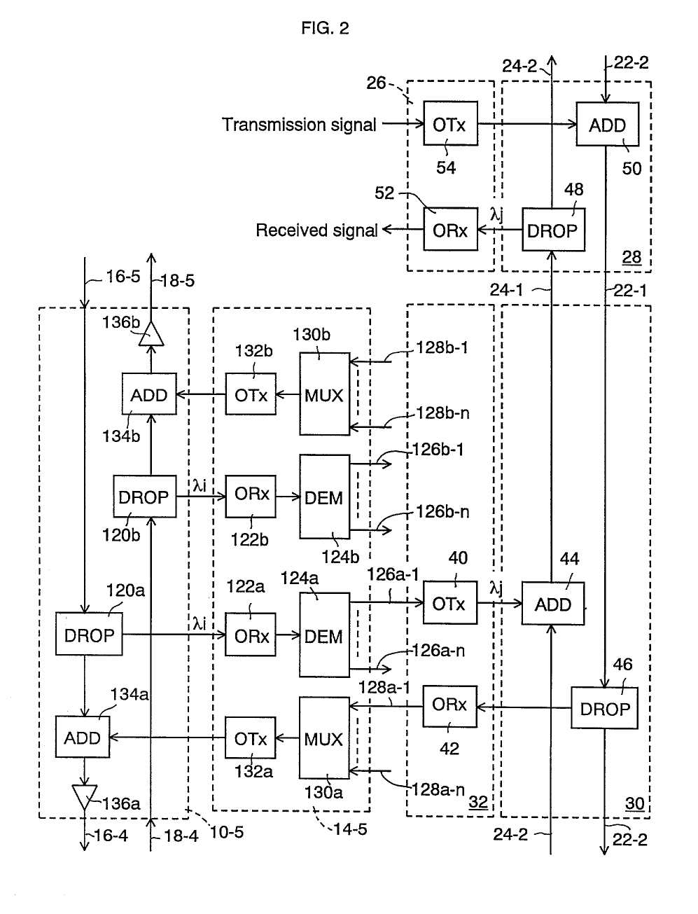

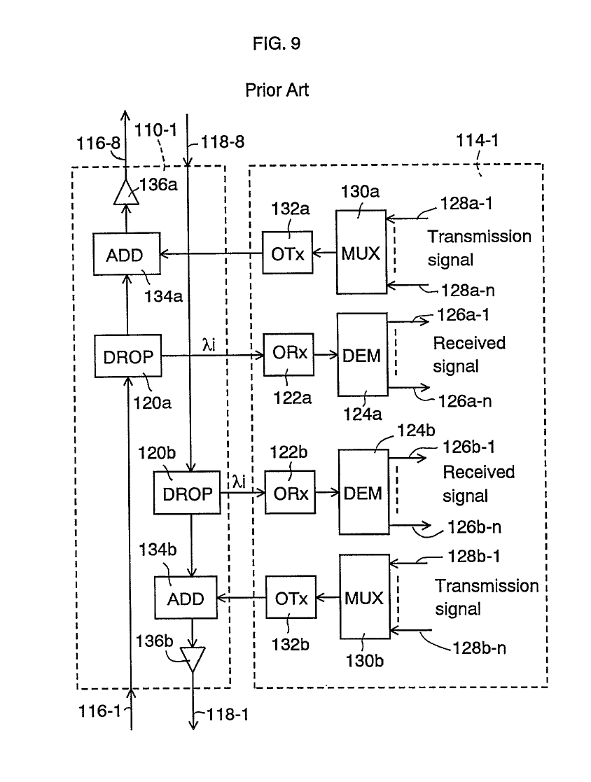

FIG. 2 shows a schematic block diagram of the optical add/drop multiplexer 10-5, the node 14-5, the node 26, the optical add/drop multiplexer 28, the optical add/drop multiplexer 30 and the connector 32. Here, the elements of the optical add/drop multiplexer 10-5 and the node 14-5 are labeled with reference numerals common to those in FIG. 9, because these structures are same as those of the conventional system shown in FIG. 9.

The connector 32 is composed of an optical transmitter 40 to convert any one of received signals (in FIG. 2, a received signal 126a-1) output from a demultiplexer 124a (or 124b) of the node 14-5 into signal light to be carried by light having a wavelength λj which is assigned to the node 26, and an optical receiver 42 to convert the signal light, which is output from a node (in FIG. 2, the node 26) connecting with the ring 20 toward a node connecting with the ring 12, into an electric signal. In addition, the optical add/drop multiplexer 30 is composed of an optical ADD circuit 44, which adds -the signal light output from the optical transmitter 40 on the optical fiber line 24 so as to enter the optical fiber 24-1, and an optical DROP circuit 46 which drops signal light (in the configuration shown in FIG. 1, all signal light is once transmitted for the node 14-5) to be transmitted for any nodes connecting with the ring 12 out of the signal light from the optical fiber 22-1 so as to apply it into the optical receiver 42.

The optical add/drop multiplexer 28 is composed of an optical DROP circuit 48 to drop signal light (in the configuration shown in FIG. 1, the whole signal light is transmitted for the node 26) having a wavelength assigned to the node 26 to be received out of the signal light input from the optical fiber 24-1 and an optical ADD circuit 50 which adds the signal light from the node 26 onto the optical fiber line 22 so as to enter the optical fiber 22-1. The node 26 is composed of an optical receiver 52 to convert the signal light from the optical DROP circuit 48 in the optical add/drop multiplexer 28 into an electric signal and an optical transmitter 54 to convert signals to be transmitted for the nodes 14-1˜14-8 connecting with the ring 12 into signal light to be carried by light having the wavelength λj which can be dropped by the optical DROP circuit 46 in the optical add/drop multiplexer 30.

The signal transmission operation from the nodes 14-1˜14-8 connecting to the ring 12 to the node 26 is explained below. When it is necessary to send a signal for the node 26, the nodes 14-1˜14-4 and 14-6˜14-8 connecting to the ring 12 transmit the signal at a wavelength (e.g. λi) in which the node 14-5 can receive. The optical DROP circuit 120a in the optical add/drop multiplexer 10-5 drops the signal light having the wavelength λi from the optical fiber 16-5, and the optical receiver 122a converts the dropped signal light into an electric signal. The demultiplexer 124a demultiplexes each signal that was multiplexed in the time domain out of the output from the optical receiver 122a. For instance, assumed that the received signal 126a-1 is a signal to be sent for the node 26, the received signal 126a-1 is applied to the optical transmitter 40 in the connector 32. When the node 14-5 itself sends a signal to the node 26, it directly applies the signal into the optical transmitter 40.

The optical transmitter 40 converts the received signal 126a-1 into signal light to be carried by light having a wavelength λj which can be received by the node 26. It is possible that the wavelength λj is identical with the wavelength λi and any wavelengths assigned to the nodes 14-1˜14-8 on the ring 12, since these wavelengths do not propagate on the same optical fiber. The output light from the optical transmitter 40 is applied into the optical ADD circuit 44 in the optical add/drop multiplexer 30. The optical ADD circuit 44 applies the signal light from the optical transmitter 40 into the optical fiber 24-1. The signal light, after propagating on the optical fiber 24-1, is dropped by the optical DROP circuit 48 in the optical add/drop multiplexer and enters the optical receiver 52 in the node 26. The optical receiver 52 converts the input signal light into an electric signal.

Next, the signal transmission operation from the node 26 to the nodes 14-1˜14-8 connecting to the ring 12 is explained below. The optical transmitter 54 in the node 26 converts the transmission signal into signal light to be carried by light having a wavelength which can be dropped by the optical DROP circuit 46 in the optical add/drop multiplexer 30 and applies it into the optical ADD circuit 50 in the optical add/drop multiplexer 28. The optical ADD circuit 50 applies the signal light from the optical transmitter 54 on the optical fiber line 22 so as to enter the optical fiber 22-1. The signal light enters the optical DROP circuit 46 in the optical add/drop multiplexer 30 to be dropped and enters the optical receiver 42 in the connector 32. The optical receiver 42 converts the input signal into an electric signal and applies it to a multiplexer 130a as a transmission signal 128a-1.

The multiplexer 130a multiplexes the output signal from the optical receiver 42 with other signals in the time domain. An optical transmitter 132a converts the output signal from the multiplexer 130a into signal light to be carried by light having a wavelength which can be dropped by an optical add/drop multiplexer connecting to the destination node. An optical ADD circuit 134a inserts the output signal light from the optical transmitter 132a on the optical fiber line 16. An optical amplifier 136a optically amplifies the output light from the optical ADD circuit 134a and applies it into the optical fiber 16-4. The signal light propagating on the optical fiber 16-4 is dropped by the optical add/drop multiplexer connecting to the destination node and enters the destination node.

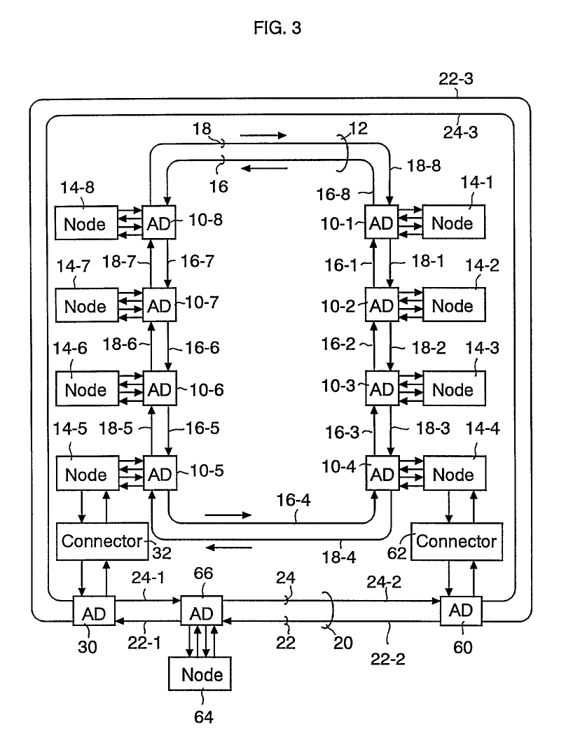

In the configuration shown in FIG. 1, when a fault occurs in the node 14-5, the connector 32 or the optical add/drop multiplexer 30, a signal cannot be transmitted/received between the node 14-1˜14-8 connecting to the ring 12 and the node 26. In order to prevent such case, a plurality of connecting lines should be disposed between the rings 12 and 20. FIG. 3 shows a schematic diagram of such configuration in which connecting lines are added.

In the modified configuration shown in FIG. 3, an optical add/drop multiplexer 60 is added on the ring 20, and the optical add/drop multiplexer 60 is connected to the node 14-4 through a connector 62. The optical fiber 22-2 shown in FIG. 1 is divided into optical fibers 22-2 and 22-3 at the optical add/drop multiplexer 60 in FIG. 3. Similarly, the optical fiber 24-2 shown in FIG. 1 is divided into optical fibers 24-2 and 24-3 at the optical add/drop multiplexer 60 in FIG. 3. The configurations of a to-be-added node 64 and the optical add/drop multiplexer 60 to connect the node 64 with the ring 20 are basically identical to those of the nodes 14-1˜14-8 connecting to the ring 12 and those of the optical add/drop multiplexers 10-1˜10-8 respectively. Obviously, when the signal in the electric stage is not multiplexed in the time domain, demultiplexers and multiplexers corresponding to the demultiplexers 124a, 124b and the multiplexers 130a, 130b can be omitted.

With the configuration shown in FIG. 3, two optical transmission lines are secured between the nodes 14-1˜14-8 connecting to the ring 12 and the node 64 connecting to the ring 20 to make the system more reliable.

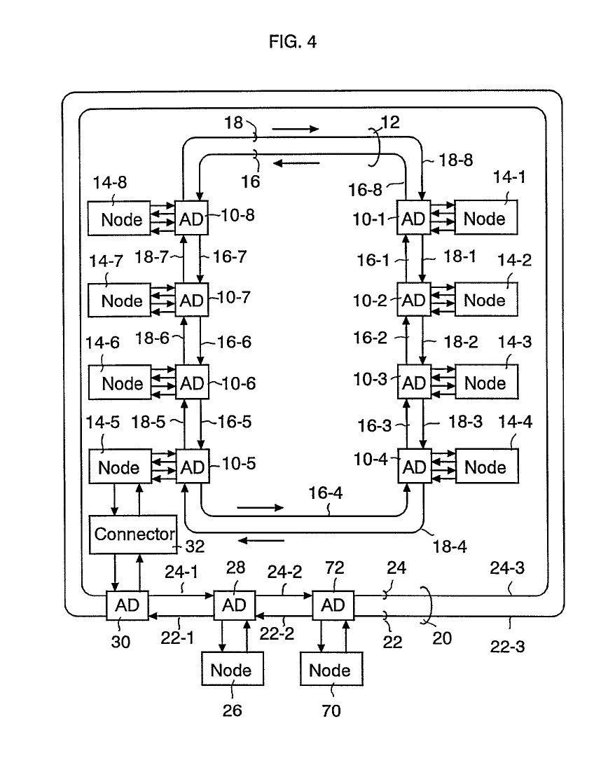

In a case that a plurality of nodes are connected to the outside ring 20, the simple way of dealing is to extend the function of the optical add/drop multiplexer 30 so as to respond to a plurality of wavelengths. For instance, in a configuration shown in FIG. 4, a node 70 and an optical add/drop multiplexer 72 to connect the node 70 with the ring 20 are added to the configuration in FIG. 3. In the configuration of FIG. 4, the optical fiber 22-2 shown in FIG. 1 is divided into optical fibers 22-2 and 22-3 at the optical add/drop multiplexer 72, and similarly the optical fiber 24-2 shown in FIG. 1 is divided into optical fibers 24-2 and 24-3 at the optical add/drop multiplexer 72.

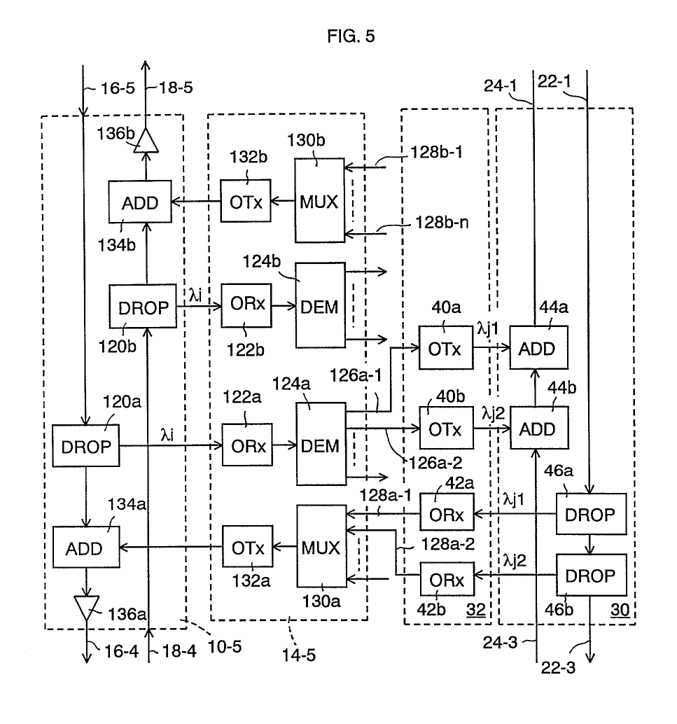

To deal with the addition of the node 70 shown in FIG. 4, the functions of the optical add/drop multiplexer 30 and the connector 32 should be extended in order to respond to wavelengths λj1 and λj2 that are different each other and assigned to the nodes 26 and 70 respectively. A configuration example of such optical add/drop multiplexer 30 and connector 32 which functions are extended as described above is shown in FIG. 5.

In FIG. 5, the node 14-5 applies the received signal 126a-1 into an optical transmitter 40a in the connector 32 to address to the node 26 and applies the received signal 126a-2 into an optical transmitter 40b in the connector 32 to address to the node 70. The optical transmitter 40a converts the input signal into signal light to be carried by light having the wavelength λj1 which can be received by the node 26, and the optical transmitter 40b converts the input signal into signal light to be carried by light having the wavelength λj2 which can be received by the node 70. An optical ADD circuit 44a in the optical add/drop multiplexer 30 applies the output light from the optical transmitter 40a onto the optical fiber 24, and an optical ADD circuit 44b applies the output light from the optical transmitter 40b onto the optical fiber 24. The signal light having the wavelength λj1 propagates on the optical fiber 24-1 until arriving at the optical add/drop multiplexer 28 to be dropped and enters the node 26. In the meanwhile, the signal light having the wavelength λj2 propagates on the optical fibers 24-1 and 24-2 until arriving at the optical add/drop multiplexer 72 to be dropped and enters the node 70.

The nodes 26 and 70 output signals to be transmitted for the nodes connecting with the ring 12 using the light having the wavelengths λj1 and λj2 as carriers respectively onto the optical fibers 22-1 and 22-2. Each signal light enters the optical add/drop multiplexer 30 after propagating the optical fibers 22-1 and 22-2. In the optical add/drop multiplexer 30, an optical DROP circuit 46a drops the light at the wavelength λj1 and applies it to an optical receiver 42a in the connector 32 while an optical DROP circuit 46b drops the light at the wavelength λj2 and applies it to an optical receiver 42b in the connector 32. The optical receivers 42a and 42b convert the input signal light into electric signals and apply them as transmission signals 128a-1 and 128a-2 into the multiplexer 130a respectively. Thereafter, those signals are processed similarly to the aforementioned and sent on the ring 12.

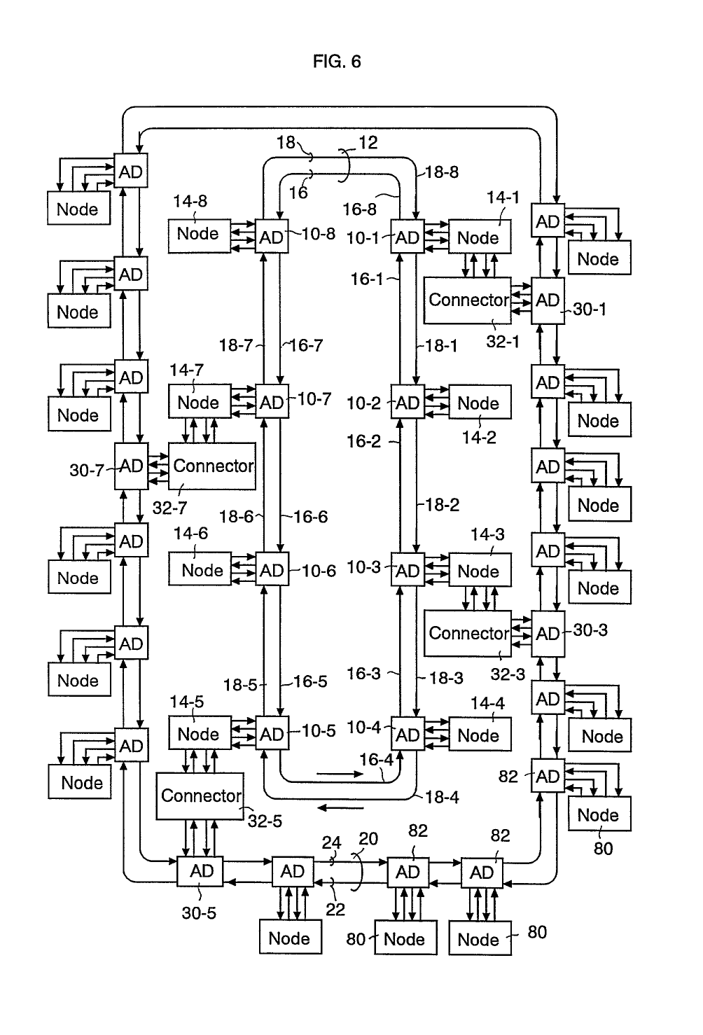

It is applicable to connect several or all of the nodes 141-1˜14-8 connecting to the existing ring 12 with the new ring 20. FIG. 6 shows a configuration in which the nodes 14-1, 14-3, 14-5 and 14-7 are connected to the added ring 20. Optical add/drop multiplexers 30-1, 30-3, 30-5 and 30-7 connect to the nodes 14-1, 14-3, 14-5 and 14-7 through connectors 32-1, 32-3, 32-5 and 32-7 respectively. In order to use both optical fibers 22 and 24 on the ring 20, the optical add/drop multiplexers 30-1, 30-3, 30-5 and 30-7 on the ring 20 are made to have a double structure similarly to the optical add/drop multiplexers 10-1-10-8 connecting to the ring 12. Correspondingly, the connectors 32-1, 32-3, 32-5 and 32-7 are also made to have a double structure. Similarly to the above explanation with reference to FIG. 4, a large number of nodes 80 are connected to optical add/drop multiplexers 82 on the ring 20. A great many nodes 80 can be added without cutting off the signal transmission on the ring 12.

In the embodiment shown in FIG. 6, a wavelength can be reused between adjacent optical add/drop multiplexers on the ring 20. For instance, in the interval between the optical add/drop multiplexers 30-3 and 30-5, all clockwise signal light having respective wavelengths output from the plurality of the nodes 80 is dropped at the optical add/drop multiplexer 30-5 so that no signal light is transmitted beyond the optical add/drop multiplexer 30-5. That is, the signal light having those wavelengths does not enter the transmission line between the optical add/drop multiplexers 30-5 and 30-7. Accordingly, in the configuration shown in FIG. 6, it is possible to improve the utilization efficiency of wavelength because signal light having the same wavelength with that of propagating on the transmission line between the optical add/drop multiplexers 30-3 and 30-5 can be transmitted on the transmission line between the optical add/drop multiplexers 30-5 and 30-7.

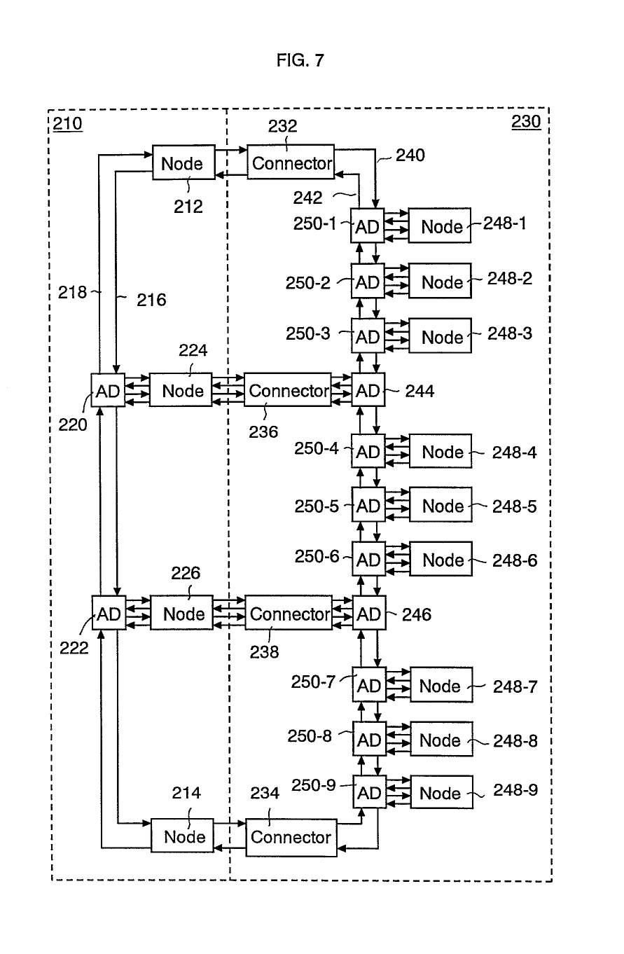

Although the embodiment of the ring transmission line was explained above, it is obvious that this invention is also applicable to a linear transmission line. FIG. 7 shows a schematic block diagram of such embodiment. In an existing transmission system 210, two optical fiber lines 216 and 218 are disposed between two nodes 216 and 218, and nodes 224 and 226 are respectively connected to optical add/drop multiplexers 220 and 222 on the optical fiber lines 216 and 218.

As a system 230 to be added in the existing system 210, connectors 232, 234, 236 and 238 are connected to the nodes 212, 214, 224 and 226. Then, optical fiber lines 240 and 242 are constructed between the connectors 232 and 234 on both ends, and optical add/drop multiplexers 244 and 246 connecting with the connectors 236 and 238 respectively are disposed on the optical fiber lines 240 and 242. Optical add/drop multiplexers 250-1˜250-9 to be connected with additional nodes 248-1˜248-9 are further constructed on the optical fiber lines 240 and 242.

The connectors 232-238 and the optical add/drop multiplexers 244 and 246 function as a device to repeat communication between the nodes 248˜248-9 and the nodes 212, 214, 224 and 226.

In each of the above embodiments, although the connectors 32, 32-1, 32-3, 32-5, 32-7, 232, 234, 236 and 238 repeat a signal in an electric stage between different optical transmission lines, it is also possible to repeat the signal in an optical stage. The utilization efficiency of a wavelength improves because a same wavelength can be used on the two optical transmission lines owing to an electric connector or an optical connector.

In the above embodiment, although the signal is time-division-multiplexed/demultiplexed in an electric stage, it is obviously applicable to process the signal in an optical stage. In such case, wavelength converters to convert the input signal light into signal light having a desired wavelength are used instead of the optical transmitters 40 and the optical receiver 42 in the connector 32.

As readily understandable from the aforementioned explanation, according to the invention, a new node can be added without influencing an existing optical transmission system. In addition, a new node can be added without cutting off communication in an existing optical transmission system.

While the invention has been described with reference to the specific embodiment, it will be apparent to those skilled in the art that various changes and modifications can be made to the specific embodiment without departing from the spirit and scope of the invention as defined in the claims.

1. An optical transmission system comprising:
a first optical transmission line to which a plurality of first nodes connect;
a second optical transmission to which at least one second node connects;
a repeating optical add/drop multiplexer disposed on the second optical transmission line; and
a signal mediator connected between any one of the plurality of the first nodes and the repeating optical add/drop multiplexer to mediate a signal between them.

2. The optical transmission system of claim 1 wherein the signal mediator comprises a first converter to convert a signal from the first node into signal light having a predetermined wavelength and apply it to the repeating optical add/drop multiplexer, and a second converter to apply a signal being carried by the signal light from the repeating optical add/drop multiplexer to the first node in a predetermined signal form.

3. The optical transmission system of claim 2 wherein the first converter comprises an optical transmitter to convert an electric signal into an optical signal and the second converter comprises an optical receiver to convert an optical signal into an electric signal.

4. The optical transmission system of claim 1 wherein a plurality of repeating optical add/drop multiplexers are further disposed on the second optical transmission line and each of the plurality of the repeating optical add/drop multiplexers connects to different one of the first nodes through different one of the signal mediators.

5. A node adding method comprising:
a step to install a second optical transmission line separately from a first optical transmission line to which a plurality of first nodes connect;
a step to dispose a repeating optical add/drop multiplexer on the second optical transmission line;
a step to connect a signal mediator between the repeating optical add/drop multiplexer and any one of the nodes connected to the first optical transmission line so as to mediate a signal between them; and
a step to connect an adding node on the second optical transmission line.

6. The node adding method of claim 5 wherein the signal mediator comprises a first converter to convert a signal from the node connected to the first optical transmission line into signal light having a predetermined wavelength and apply it to the repeating optical add/drop multiplexer and a second converter to apply a signal being carried by the signal light from the repeating optical add/drop multiplexer to the node in a predetermined signal form.

7. The node adding method of claim 6 wherein the first converter comprises an optical transmitter to convert an electric signal into an optical signal and the second converter comprises an optical receiver to convert an optical signal into an electric signal.

8. The node adding method of claim 5 further comprising a step to additionally dispose a repeating optical add/drop multiplexer on the second optical transmission line and a step to connect another signal mediator between the added repeating optical add/drop multiplexer and another node connected to the first optical transmission line so as to mediate a signal between them.
